(19) United States
(12) Patent Application Publication
(10) Pub. No.: US 2013/0346646 A1
(43) Pub. Date: Dec. 26, 2013

(54) USB DISPLAY DEVICE OPERATION IN ABSENCE OF LOCAL FRAME BUFFER

(71) Applicant: Robert McVay, Portland, OR (US)

(72) Inventor: Robert McVay, Portland, OR (US)

(73) Assignee: FRESCO LOGIC INC., Beaverton, OR (US)

(21) Appl. No.: 13/543,748

(22) Filed: Jul. 6, 2012

Related U.S. Application Data
(60) Provisional application No. 61/662,131, filed on Jun. 20, 2012.

(51) Int. Cl. G06F 3/00

(52) U.S. Cl. 710/52

(57) ABSTRACT

Briefly, in accordance with one embodiment, for example, USB display device operation is disclosed in absence of a local frame buffer.

### COPYRIGHT NOTICE

©2012 Fresco Logic Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure relates to providing a computer display using USB standard connectivity and, in particular, to a method of and system for providing a video display for a computer over a USB link without use of a local frame buffer.

### BACKGROUND INFORMATION

There are existing solutions for providing a computer display using a universal serial bus (USB). In all currently available implementations, a USB device maintains a local frame buffer, by which an image is rendered and presented on a display device, such as a monitor, for viewing by a user. The USB link is used to provide real-time updates to the local frame buffer or multiple local frame buffers, which are then reflected in the rendered output.

Examples of prior art solutions are the Displaylink and SMSC USB-to-video adapters, both of which make use of a local frame buffer. Solutions based on Magic Control Technology (MCT) technology require first-in, first-out data. Prior art for implementing solutions to overcome inconsistencies in the connectivity to the local frame buffer are the Netflix (and other provider) streaming video interfaces, which dynamically adjust the quality of the transmitted video stream based on available bandwidth.

### SUMMARY OF THE DISCLOSURE

In the disclosed system, the frame buffer is moved from the USB device to the USB host computer platform and resides in host memory of the computer. Instead of sending updates to the frame buffer, the entire frame buffer is sent for each frame and is presented directly to the display device. In a preferred embodiment of the disclosed system, the contents of the frame buffer may be left in the native alignment of the host computer platform, transferred to the USB device in that native format, and then rearranged by the USB device prior to display. The disclosed system implements a method of overcoming problems caused when the USB device does not have access to a local frame buffer.

The elimination of the local frame buffer and associated logic provides a significantly reduced cost. By keeping the frame buffer in the host side, where the cost of memory is essentially free, the total solution cost is dramatically lowered, For instance, a 1920×1080 frame buffer with 24-bit color would require almost 50 million bits of memory. In some systems, multiple frame buffers may be stored. By contrast, the disclosed system can operate with fewer than 1 million bits of memory, which represents a 98% reduction in memory storage requirements and a significant reduction in cost.

Allowing the frame buffer to remain in the native format of the host system results in improved performance and reduced computational resources on the host machine. By keeping the native format, copy operations may be eliminated compared to systems that require transmission to the USB device in a first-in, first-out data ordering. A set of methods implemented to overcome the immediate challenges presented in a frame buffer-less display includes methods to dynamically adjust the picture quality to meet the bandwidth requirements imposed by the link between the frame buffer and the display device.

Additional aspects and advantages will be apparent from the following detailed description of preferred embodiments, which proceeds with reference to the accompanying drawings.

### BRIEF DESCRIPTION OF THE DRAWINGS

FIGS. 1 and 2 are block diagrams of USB display systems configured in accordance with, respectively, the prior art approach of including a local frame buffer in the USB device and the disclosed approach of eliminating the local frame buffer from the USB device and using host computer memory stores.

### DETAILED DESCRIPTION OF PREFERRED EMBODIMENTS

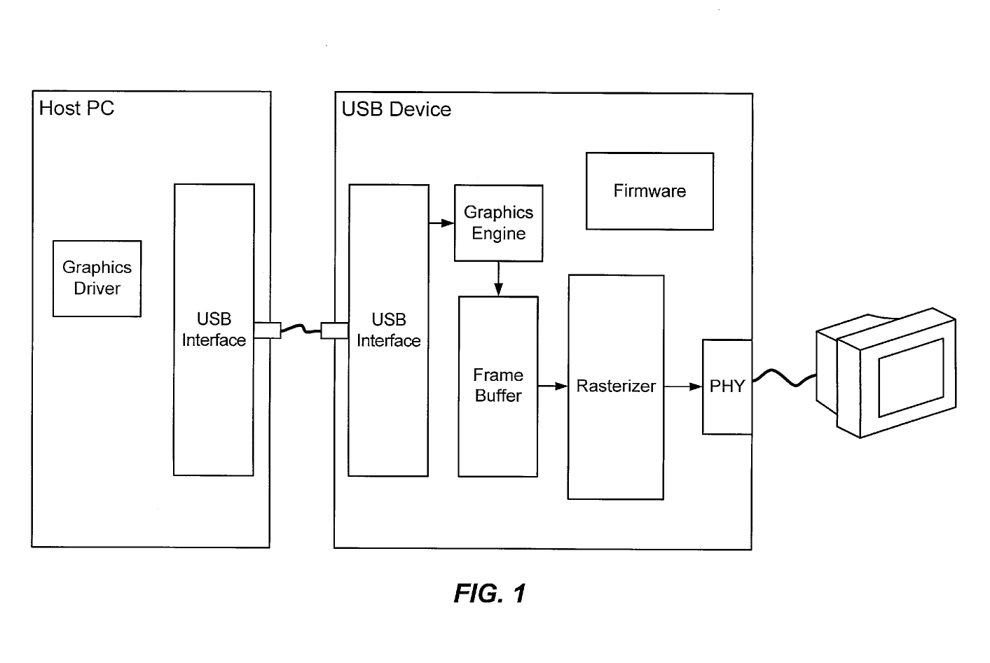

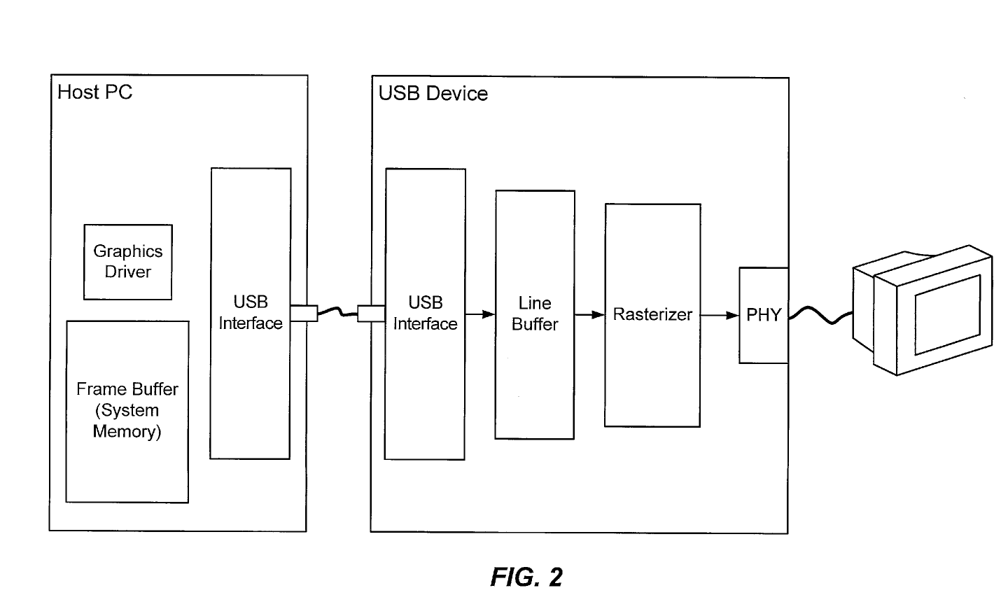

Inspection of FIGS. 1 and 2 reveals the movement of the large frame buffer from the USB device side to the USB host computer (PC) platform side. In addition, there are some other display components used in the traditional approach that are used to take the partial frame updates provided over the USB connection and translate them into the frame buffer. In most cases, a microprocessor and associated RAM/ROM are also required to make this translation, In addition, there may be dedicated de-compression hardware for such protocols as MP4 or H.264. All of these components are eliminated by the disclosed system, since the complete frame buffer image is transmitted in its native format (or nearly so) for simple direct display to the display device.

Although it may appear as though implementation of the disclosed method entails merely moving memory from one place to another, skilled persons will appreciate that the memory already exists in the host computer and may be considered essentially cost free. In fact, the memory requirements for the disclosed system may be no greater than the memory requirement of the traditional solution depicted in FIG. 1. Since the cost on the host side is equal for all intents and purposes, the cost savings on the USB device side can be taken at full value. The savings of the memory alone (50 million bits) results in a substantial cost reduction. The removal of the other associated logic is also significant. Products making use of the disclosed system implementation become much less expensive to manufacture and deploy than products not making use of the disclosed system implementation.

Leaving the contents of the frame buffer in the native alignment of the host computer, as it pertains to the order in which data are transmitted from the host PC to the USB display device, provides value in reducing the amount of processing and data movement required by the host PC. If the USB device requires data in a particular format, the host processor might be required to reorder the data to fit that format. In the disclosed system, the USB device allows the host computer to leave the memory in the native format, whether generated by standard driver software or by GPU hardware. In this way, the translation from host format to device format may be avoided, thereby saving CPU overhead. This means that the solution may be capable of working on less powerful machines or higher resolution may be supported as compared with that afforded by solutions not making use of the disclosed system implementation.

Implementing methods to overcome issues with removal of the local frame buffer provides value in producing good user experience in those cases where the lack of a local frame buffer would otherwise make the solution unworkable. A component common to these methods is dynamic compression. Dynamic compression is a form of variable rate compression that is targeted at creating the best possible user experience based on the dynamic bandwidth availability of the host computer and the dynamic bandwidth requirements of the content. The methods are implemented by use of a number of tunable parameters and a software algorithm for adapting those parameters to the available bandwidth and content.

One of the strengths of the method is that, since it is frame based and the bandwidth requirements are frame based, a number of metrics are automatically generated with respect to the dynamic bandwidth requirement of the content. For example, a full-screen video generally requires much more bandwidth than does an e-mail application. When the user starts playing a full screen video, this activity can be detected by the system in a single frame and adjustments can be made immediately to change the tunable parameters to a lower image fidelity that would fit within the current bandwidth limit. The tunable parameters include, for example, compression quality, color depth, frame rate, display resolution, and content blacking.

By applying these methods, a display can be provided in almost any combination of bandwidth provisioning and any content. Naturally, the quality of the displayed content will vary in direct proportion to the mismatch between content requirement and bandwidth availability. The solution provides methods to allow the software to dynamically adjust these parameters on a frame-by-frame (or even finer grained) basis and communicate these adjustments to hardware in a coordinated fashion so that the user is not aware or does not perceive that the adjustments are happening.

It will be obvious to those having skill in the art that many changes may be made to the details of the above-described embodiments without departing from the underlying principles of the invention.

1. An apparatus comprising: a USB display system configured with a USB device with no local frame buffer included and a host computer platform having a host memory configured with frame buffer memory stores.

2. The apparatus of claim 1, in which the frame buffer contents remain in the native format of the host computer platform.

3. The apparatus of claim 1, in which the host computer platform is implemented with software to perform dynamic compression.

4. The apparatus of claim 3, in which the software is able to perform dynamic compression in response to episodic loss of connectivity between the USB device and the host computer platform.

5. The apparatus of claim 3, wherein the software is able to perform dynamic compression by adjusting one or more tunable parameters to lower image fidelity of transmitted content in a manner to fit within available bandwidth.

6. The apparatus of claim 5, wherein the tunable parameters comprise one or more of the following: compression quality; color depth; frame rate; display resolution and/or content blacking.

7. The apparatus of claim 3, wherein the software is capable of performing dynamic compression so as to effectively provision bandwidth dynamically to meet the dynamic bandwidth of content being transmitted for display.

8. The apparatus of claim 7, wherein the software is capable of provisioning bandwidth on a frame-by-frame or even finer grained basis.

9. An apparatus comprising: a USB device with no local frame buffer capable of being configured to be operable in a system that includes a host computer, the system being operable to display content transmitted from the host computer via a USB port.

10. The apparatus of claim 9, wherein the host computer of the system being implemented with software to perform dynamic compression.

11. The apparatus of claim 10, in which the software is able to perform dynamic compression in response to episodic loss of connectivity between the USB device and the host computer platform.

12. The apparatus of claim 10, wherein the software is able to perform dynamic compression by adjusting one or more tunable parameters to lower image fidelity of transmitted content in a manner to fit within available bandwidth.

13. The apparatus of claim 12, wherein the tunable parameters comprise one or more of the following: compression quality; color depth; frame rate; display resolution and/or content blacking.

14. The apparatus of claim 10, wherein the software is capable of performing dynamic compression so as to effectively provision bandwidth dynamically to meet the dynamic bandwidth of content being transmitted for display.

15. The apparatus of claim 14, wherein the software is capable of provisioning bandwidth on a frame-by-frame or even finer grained basis.

16. A method of transmitting content from a host computer system for display via a USB port comprising: transmitting the content to a USB device with no local frame buffer, the USB device coupled to the host computer system via the USB port; wherein the transmitting comprises transmitting the content in a manner that meets bandwidth requirements of the content being transmitted.

17. The method of claim 16, wherein transmitting the content comprises transmitting content that has been dynamically compressed.

18. The method of claim 17, wherein the content has been dynamically compressed as to effectively provision bandwidth dynamically to meet the dynamic bandwidth of the content being transmitted for display.

19. The method of claim 18, wherein the content has been dynamically compressed on a frame-by-frame or even finer grained basis.
